(19) United States
(12) Patent Application Publication
(10) Pub. No.: US 2009/0239118 A1
(43) Pub. Date: Sep. 24, 2009

(54) CATALYST LAYER FOR SOLID POLYMER FUEL CELL, MEMBRANE ELECTRODE ASSEMBLY, AND FUEL CELL

(75) Inventors: Akira Morita, Kawasaki-shi (JP); Yoshinobu Okumura, Machida-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/406,767

(22) Filed: Mar. 18, 2009

(30) Foreign Application Priority Data
Mar. 19, 2008 (JP) 2008-072354

(51) Int. Cl. H01M 8/10

(52) U.S. Cl. 429/30

(57) ABSTRACT

A catalyst layer of a solid polymer fuel cell includes a catalyst structural body, a membrane present on at least part of a surface of the catalyst structural body and including a first water-repellent material having a functional group, particles having a second water-repellent material, and an electrolyte.

### BACKGROUND OF THE INVENTION

1. Field of the Invention

The present invention relates to a catalyst layer for a solid polymer fuel cell, a membrane electrode assembly using same, and a fuel cell.

2. Description of the Related Art

In recent years, the functionality of portable devices has been increasing, thereby raising power consumption of the devices. Accordingly, high expectations have been placed on fairly small-size fuel cells having a relatively high energy density as power sources for portable devices. Among fuel cells of various systems, fuel cells using pure hydrogen as a fuel feature a relatively high output and make it possible to reduce the size of the system. Because it is possible that fuel cells for installation in portable devices will be used in various environments, it may be desirable that performance thereof be affected only to a limited extent by temperature and humidity, even when they vary significantly. Furthermore, because it may be necessary to reduce fuel cells further in size to enable installation in portable devices, it may be desirable that a fuel cell be realized substantially without intensive use of peripheral devices such as a pump for supplying reactive gases. In other words, when internal components of a fuel cell are designed, materials and structures may be selected so as to enable flexible response to variations in the environment in which the fuel cell is used.

FIG. 2 shows a schematic cross-sectional view of a unit cell of a typical fuel cell. As shown in FIG. 2, a fuel cell typically includes as the main structural components an electrolyte membrane 21, a pair of catalyst layers 22, a pair of gas diffusion layers 23 composed of a carbon porous material, a pair of current collectors 24 having reactive gas channels, and a seal member 25 for preventing the reactive gases from leaking, and these components constitute a single cell. The catalyst layers 22 serve to enhance the decomposition reaction of hydrogen and air that are the reactive gases.

Where hydrogen is supplied to an anode during power generation in the fuel cell, electrons and protons are generated under the effect of the catalyst. The protons pass through the electrolyte membrane 21 and are bonded on the cathode with electrons and oxygen present in the air supplied to the cathode, thereby generating water. Where the generated water is accumulated and the catalyst layer 22 becomes immersed in water, the supply of reactive gases may be inhibited, and a state may be assumed in which power generation becomes difficult. Therefore, managing water in a fuel cell may be extremely important, and it may also be necessary that the generated water be efficiently discharged from the catalyst layer to maintain an adequate supply of the reactive gases.

Mixing a fluororesin such as PTFE with a catalyst metal and an electrolyte material and dispersing the mixture in a catalyst layer has been investigated as a method for imparting water repellency with the object of enhancing water discharge from the catalyst layer of a fuel cell.

Japanese Patent Laid-Open No. 2006-286564 discloses a catalyst layer of a solid polymer fuel cell provided with a mixture including a carbon material, a cation-exchange resin, and a catalytic metal and a fluororesin having no ion exchange groups. In this catalyst layer, a ratio of the fluororesin having no ion exchange groups to the carbon material is equal to or higher than 30 mass % and equal to or lower than 60 mass %, and a porosity of the catalyst layer is equal to or higher than 60% and equal to or lower than 85%.

Furthermore, Japanese Patent Laid-Open No. 2007-287663 discloses a direct-oxidation fuel cell in which a water-repellent layer is formed in a portion of an electrolyte membrane that surrounds an anode and a cathode with the object of inhibiting abrupt expansion and deformation of the electrolyte membrane that occur due to water treatment of a membrane electrode assembly or supply of liquid fuel.

However, the configuration described in Japanese Patent Laid-Open No. 2006-286564 may not provide sufficient water repellency. Japanese Patent Laid-Open No. 2007-287663 finds water repellency of the electrolyte membrane as a countermeasure to liquid fuel crossover, but does not touch on water repellency or flooding of the catalyst layer.

### SUMMARY OF THE INVENTION

Aspects of the present invention relate to a catalyst layer of a solid polymer fuel cell, including: a catalyst structural body; a membrane present on at least part of a surface of the catalyst structural body and including a first water-repellent material having a functional group; particles having a second water-repellent material; and an electrolyte. Another aspect of the present invention relates to a catalyst layer of a solid polymer fuel cell, including: a catalyst structural body; a membrane present on at least part of a surface of the catalyst structural body and comprising a first fluororesin having a functional group selected from the group consisting of a silane group, a phosphate group, a carboxyl group, and a hydroxyl group; particles comprising a second fluororesin; and an electrolyte.

Further features of the present invention will become apparent from the following description of exemplary embodiments with reference to the attached drawings.

### BRIEF DESCRIPTION OF THE DRAWINGS

FIG. 1 is a schematic diagram illustrating a partial cross-sectional structure of unit cells of fuel cell of an example and a comparative example.

FIG. 2 is a schematic cross-sectional view of a unit cell of a typical fuel cell.

FIG. 3A is a surface SEM image illustrating a catalyst structural body and a particle including a fluororesin.

FIG. 3B is a sectional SEM image illustrating a catalyst structural body and a particle including a fluororesin.

FIG. 4 is a graph illustrating a fuel cell output of an example before and after an endurance test.

### DETAILED DESCRIPTION OF THE INVENTION

The present invention will be described below in greater detail.

One aspect of the present invention resides in a catalyst layer of a solid polymer fuel cell, including: a catalyst structural body; a membrane present on at least part of a surface of the catalyst structural body and including a water-repellent material having a functional group; particles having a water-repellent material; and an electrolyte.

The catalyst structural body may include a catalytic metal. Therefore, the catalyst structural body may comprise and may even consist only of a catalytic metal, or may comprise both a catalyst and another component, as in catalyst-supporting carbon, for example. Furthermore, in one version the catalytic metal may comprise platinum. When the catalytic metal includes a metal other than platinum, one or more of the following components may be included: B, C, N, Al, Si, P, Ti, V, Cr, Fe, Co, Ni, Cu, Zr, Nb, Mo, Ru, Rh, Pd, Ag, In, Sn, Hf, Ta, W, Re, Os, Ir, and Au.

The catalytic structural body may have a variety of shapes, such as for example at least one of a particulate shape, a rod-like shape, and a dendritic shape. In one version, the dendritic shape may be provided.

A catalytic structural body having a particulate shape can be formed, for example, by reducing an aqueous solution of a metal shape, and a catalyst structural body having a dendritic shape can be produced by, for example, a vacuum vapor deposition method, in a broad meaning thereof, such as for example by one or more of reactive sputtering, reactive electron beam deposition, and reactive ion plating. As another example, in a version where the catalyst comprises platinum, the catalyst structural body can be obtained by forming a platinum oxide PtOₓ having a dendritic shape by reactive sputtering and then reducing the oxide.

The catalyst layer can include the catalyst structural body, a water-repellent material, and an electrolyte. The catalyst layer including the electrolyte can provide a proton path to the vicinity of the catalyst structural body. Furthermore, where the electrolyte and water-repellent material are mixed and added to the catalyst layer, it may be possible to disperse particles of the water-repellent material with better uniformity. NAFION™ produced by Du Pont is an example of a commercial electrolyte.

Where a particle size of the particles including the water-repellent material is relatively large, a resistance at an interface of the catalyst layer and the gas diffusion layer or polymer electrolyte membrane may increase. Therefore, in one version particles of a relatively small size may be used. For example, a powder may be used that has particles with an average size of equal to or greater than 0.1 μm and equal to or less than 0.5 μm, such as equal to or greater than 0.15 μm and equal to or less than 0.3 μm.

When the amount added of the particles including the water-repellent material is too small, the water repellent effect may be degraded, and when the amount is too large, the electric resistance increases and output can be decreased. Accordingly, in one version the particles including the water-repellent material may be added for use at a ratio of equal to or greater than 10 mass % and equal to or smaller than 60 mass %, such as equal to or greater than 20 mass % and equal to or smaller than 50 mass % of the catalyst structural body.

For similar reasons, the water-repellent material that is a part of the membrane present on at least part of the surface of the catalyst structural body, and including the water-repellent material having the functional group, may be present at a ratio within a range of equal to or greater than 1 μg/cm² and equal to or less than 1000 μg/cm², such as equal to or greater than 5 μg/cm² and equal to or less than 500 μg/cm².

In one version, the water-repellent material constituting at least a portion of the particles, as well as the water-repellent material having the functional group and forming at least a portion of the membrane, may both comprise a fluororesin.

For example, at least one of polytetrafluoroethylene (PTFE), a perfluoroalkoxyalkane, an ethylene-tetrafluoroethylene copolymer, a perfluoroethylene-propene copolymer, polyvinylidene fluoride, and an ethylene-chlorotrifluoroethylene copolymer, may be used as the fluororesin constituting at least a portion of the particles.

As another example, a fluororesin having a functional group of at least one kind selected from the group consisting of a silane group, a phosphate group, a carboxyl group, and a hydroxyl group may be used as the water-repellent material having the functional group and forming at least a portion of the membrane. Examples of the fluororesin having the silane group include NOVEC™ (Sumitomo 3M Co., Ltd.) and FLUOROLINK™ (Solvay Selexis KK). Examples of the fluororesin having the phosphate group include FLUOROLINK™ (Solvay Selexis KK). Examples of the fluororesin having the carboxyl group and the hydroxyl group include LUMIFLON™ (Asahi Glass Co., Ltd.), CEFRAL COAT (Central Glass Co., Ltd.), and FLUOROLINK™ (Solvay Selexis KK).

A second aspect of the present invention resides in a membrane electrode assembly including the catalyst layer according to the first aspect of the present invention and a polymer electrolyte membrane.

A third aspect of the present invention resides in a fuel cell including the membrane electrode assembly according to the second aspect of the present invention, a gas diffusion layer, and a current collector.

An embodiment of a fuel cell in accordance with the present invention will be described below in greater detail.

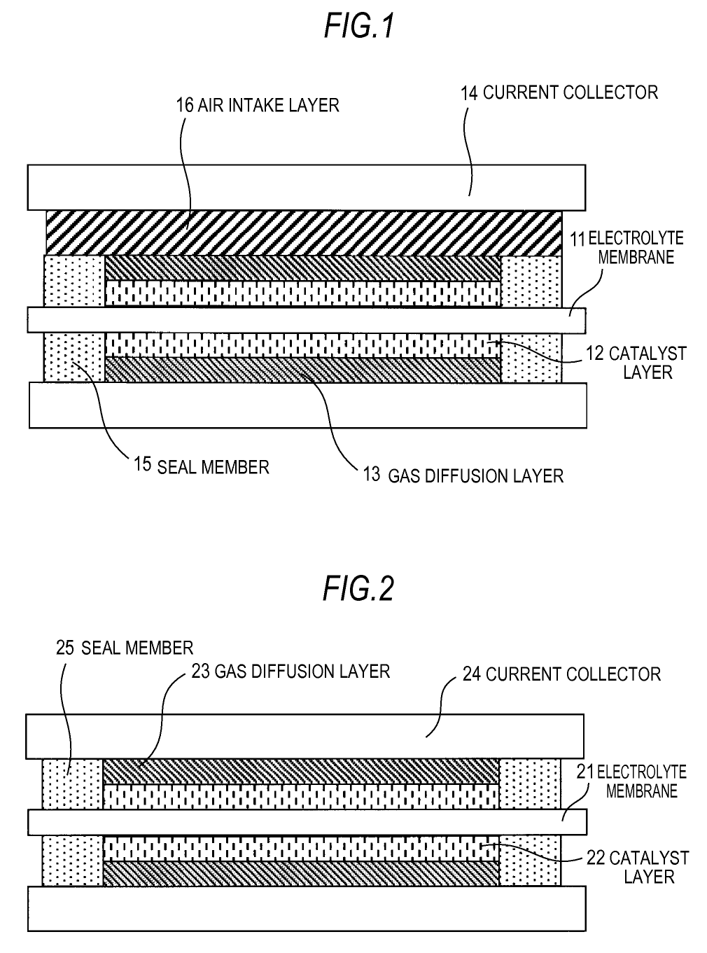

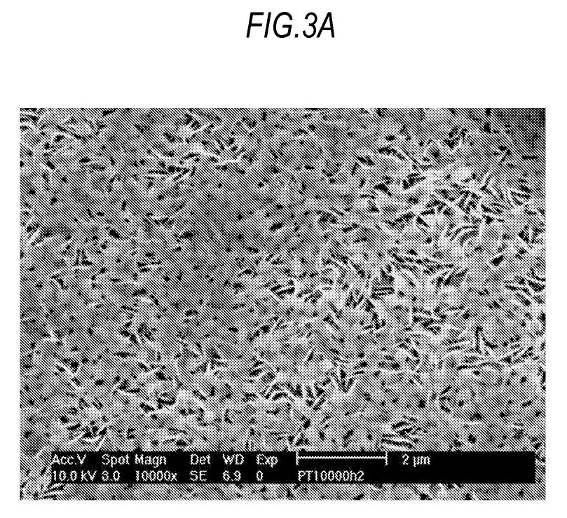

FIG. 1 is a schematic diagram illustrating a partial cross-sectional structure of an embodiment of a unit cell of a fuel cell in accordance with the present invention. The fuel cell in accordance with the present invention has an electrolyte membrane 11, a pair of catalyst layers 12 provided on both surfaces of the electrolyte membrane 11 and in contact therewith, a pair of gas diffusion layers 13 provided on respective catalyst layers 12 and in contact therewith, a pair of current collectors 14 having reactive gas channels that are provided on respective gas diffusion layers 13 and in contact therewith, a seal member 15 for maintaining gas tightness of the reactive gas, and an air intake layer 16 for introducing the air as an oxidizing agent.

As an example, an ion exchange membrane comprising a perfluorosulfonic acid polymer or a hydrocarbon polymer may be used as the electrolyte membrane 11, although the example of the membrane used herein is not intended to be limiting. For example, NAFION™ produced by Du Pont can be employed as the commercial electrolyte membrane 11.

The catalyst layer 12 corresponds to the above-described catalyst layer in accordance with the present invention.

An example of a method for manufacturing the catalyst layer will be explained below. According to this example, initially, a platinum oxide catalyst having a dendritic structure is formed on the surface of a polytetrafluoroethylene sheet by a reactive sputtering method in which Ar and O₂ are introduced, and a catalyst sheet is produced.

Then, an ionomer of NAFION™ produced by Du Pont and a polytetrafluoroethylene powder comprising particles including a water-repellent material are dispersed in an organic solvent such as isopropyl alcohol. The solution obtained by sufficient dispersion is then dropped on the catalyst sheet and dried.

The platinum oxide catalyst is then reduced by exposing the catalyst sheet to an H₂ atmosphere and a platinum catalyst sheet is obtained.

The platinum catalyst sheet and a NAFION™ sheet, which is a polymer electrolyte membrane, are then laminated and pressed together under heating, thereby transferring the catalyst layer from the polytetrafluoroethylene sheet onto the NAFION™ surface and producing a membrane electrode assembly. Finally, the membrane electrode assembly is immersed in a solution obtained by dissolving a water-repellent material having a functional group in an organic solvent. After a certain period, the membrane electrode assembly is pulled up and the organic solvent is evaporated, thereby causing adhesion of the water-repellent material having a functional group to the catalyst layer in the form of a film.

Where the amount added of the water-repellent material having a particulate shape is too low, the water repellent effect may be degraded, and when this amount is too high, the resistance may be increased thereby decreasing the output. Therefore, in one version, the water-repellent material having the particulate shape can be added for use at a ratio of equal to or higher than 10 mass % and equal to or lower than 60 mass % in relation to the catalyst structural body. For a similar reason, in one version, the amount added of the film-shaped water-repellent material may be within a range of equal to or greater than 1 μm/cm² and equal to or less than 1000 μm/cm².

In one version, particles including the water-repellent material may be contained in the catalyst layer at a ratio of equal to or higher than 10 mass % and equal to or lower than 60 mass % of the catalyst structural body. Furthermore, the film comprising the water-repellent material having the functional group may be present on the surface of the catalyst structural body at a ratio equal to or greater than 1 μm/cm² and equal to or less than 1000 μm/cm².

The gas diffusion layer 13 may be formed from, for example, a carbon base material and a carbon fine particle layer.

The carbon base material may be provided in the form of, for example, at least one of carbon paper, carbon cloth, or carbon felt. Furthermore, in order to facilitate further the management of water, in one version a hydrophobic material such as PTFE may be contained in the carbon base material. From the standpoint of electric resistance, gas diffusion ability, and moisture retention ability and strength of the electrolyte membrane, the thickness of the carbon base material may be, for example, within a range of equal to or greater than 150 μm and equal to or less than 250 μm.

In one version, the carbon fine particle layer may be formed by mixing a carbon material with PTFE and coating the mixture on the surface of a carbon base material. Examples of suitable carbon materials may include one or more of carbon black, such as furnace black and/or acetylene black, carbon fibers, carbon nanotubes, fullerenes, and graphite.

In order to provide electric conductivity and water repellency of the carbon porous material, in one version the mixing ratio of the carbon material and PTFE may be within a range of equal to or greater than 15 mass % and equal to or less than 45 mass % for PTFE. The average particle size of the carbon material used may be within a range of equal to or greater than 10 nm and equal to or less than 50 nm.

In one version, a metal plate obtained by plating stainless steel with gold, or a plate obtained by molding carbon fine particles with a resin, can be used as the current collector 14 provided with a channel.

The seal member 15 can comprise, for example, at least one of a rubber gasket from a silicone rubber, a viton rubber and an adhesive of a hot-melt type.

A member having electron conductivity and permeable to air can be used as the air intake layer 16. For example, in one version a foamed metal such as nickel can be used.

### EXAMPLES

Examples of the present invention will be described below.

### Example 1

A polytetrafluoroethylene (abbreviated hereinbelow as PTFE) sheet was cut. Then, Ar and O₂ were introduced, platinum oxide was caused to adhere to the PTFE sheet surface and a dendritic platinum oxide catalyst sheet was produced using a sputtering apparatus (ULVAC Co.). Two square pieces of the platinum oxide catalyst sheet with a side of 2.24 cm were cut out.

A dispersion prepared by dispersing particulate PTFE (average particle size: 0.24 μm) to 60 mass % in water was added to an isopropyl alcohol solution prepared by dissolving a NAFION™ Ionomer (manufactured by Du Pont) to 1 mass %, so as to obtain a PTFE content ratio of 1.8 mass %. A NAFION™-PTFE mixed solution was then produced by ultrasonically dispersing for 10 min.

A total of 36 μl of the NAFION™-PTFE mixed solution was then dropped using a pipette on one square catalyst sheet with a side of 2.24 cm. A total of 36 μl of a 1 mass % NAFION™ isopropyl alcohol solution containing no PTFE was dropped on the other cut catalyst sheet. The two sheets were then allowed to stay to evaporate the solvent completely, thereby producing a catalyst sheet for a cathode and a catalyst sheet for an anode, respectively.

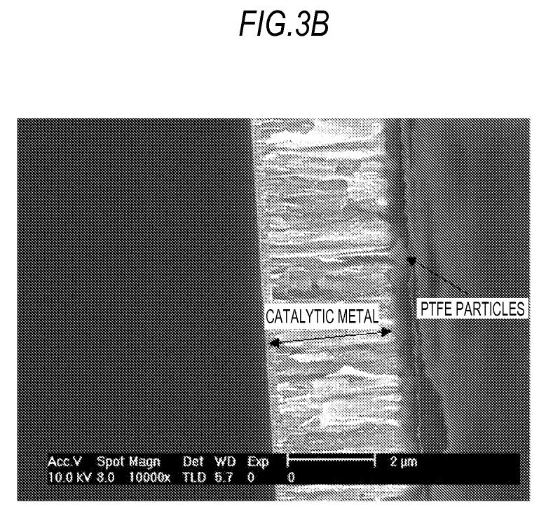

The surface and cross section of a catalyst sheet for a cathode produced in the same manner as described above, except that a silicon substrate was used instead of the PTFE sheet, was observed under a SEM (scanning electron microscope). The SEM image is shown in FIG. 3A and FIG. 3B. FIG. 3A shows a surface SEM image, and FIG. 3B shows a cross-sectional SEM image. In the surface SEM image shown in FIG. 3A, PTFE particles are uniformly dispersed on the catalyst layer surface and some of them have infiltrated into the gaps of the dendritic catalyst. The cross-sectional SEM image shown in FIG. 3B demonstrates that PTFE particles are present close to the surface.

The size of PTFE particles on the catalyst layer can be evaluated by such SEM observations. The average particle size of PTFE particles on the catalyst layer in the present example was 0.26 μm.

The catalyst sheets were placed under a gas atmosphere of a helium-hydrogen mixture, the platinum oxide catalyst was reduced, and a platinum catalyst sheet was obtained. The measured weight of platinum was about 6 mg/cm².

The PTFE particles were added at about 1.3 mg/cm², and the content ratio of the PTFE particles with respect to the platinum catalyst structural body was about 21.7 mass %. Furthermore, the surface area of the platinum catalyst structural body evaluated by the CO adsorption method was 20 cm²/mg.

A square NAFION™ sheet (NRE 212, manufactured by Du Pont) with a side of 4 cm was then prepared as an electrolyte membrane and sandwiched between the platinum catalyst sheet for a cathode and a platinum catalyst sheet for an anode so that the catalyst was in contact with NAFION™. Hot-press bonding was then performed using a hot press (manufactured by Tester Sangyo KK) and a membrane electrode assembly was produced.

The membrane electrode assembly was immersed into a NOVEC EGC-1720™ (manufactured by Sumitomo 3M Co., Ltd.) solution and immediately pulled out therefrom and the solution was dried. A membrane electrode assembly A was thus produced. In order to determine the amount of NOVEC™ added to the catalyst structural body, the increase in weight during drying after immersing the platinum catalyst sheet into the NOVEC EGC-1720™ solution was measured. The result was 0.9 mg/cm². Therefore, the amount of NOVEC™ present on the surface of the catalyst structural body was 7.5 μg/c².

### Example 2

A membrane electrode assembly B was produced in the same manner as the membrane electrode assembly A, except that FLUOROLINK S10™ (manufactured by Solvay Selexis KK) was used instead of NOVEC EGC-1720™ (manufactured by Sumitomo 3M Co., Ltd.) in the production method of Example 1.

### Example 3

A membrane electrode assembly C was produced in the same manner as the membrane electrode assembly A, except that FLUOROLINK TLS 5007™ having a phosphoric acid group (manufactured by Solvay Selexis KK) was used instead of NOVEC EGC-1720™ (manufactured by Sumitomo 3M Co., Ltd.) in the production method of Example 1.

### Example 4

A membrane electrode assembly D was produced in the same manner as the membrane electrode assembly A, except that a dispersion in which particulate perfluoroalkoxyalkane (PFA) (average particle size: 0.18 μm) was dispersed in water in an amount of 55 mass % was used instead of the PTFE dispersion in the production method of Example 1.

### Comparative Example 1

A membrane electrode assembly E was produced in the same manner as the membrane electrode assembly A, except that immersing into the NOVEC EGC-1720™ (manufactured by Sumitomo 3M Co., Ltd.) solution as in Example 1 was not performed.

### Comparative Example 2

A membrane electrode assembly F was produced in the same manner as the membrane electrode assembly B, except that FOMBLIN M03™ (manufactured by Solvay Selexis KK), which is a solution of a fluororesin having no functional groups, was used instead of the FLUOROLINK S10™ used in Example 2.

### Comparative Example 3

A membrane electrode assembly G was produced in the same manner as the membrane electrode assembly A except that without using the NAFION™-PTFE mixed solution, a total of 36 μl of the 1 mass % NAFION™ isopropyl alcohol solution containing no PTFE was dropped on both of the catalyst sheet for the cathode and the catalyst sheet for the anode.

The membrane electrode assemblies of the examples and comparative examples that were obtained in the above-described manner were used as cells of fuel cells, and fuel cell evaluation was performed.

A gas diffusion layer LT1200N manufactured by BASF Fuel Cell Inc. was arranged as the gas diffusion layer so as to be in contact with the catalyst layer of the cathode side of the membrane electrode assemblies A to E, and LT2500W manufactured by BASF Fuel Cell Inc. was arranged as the gas diffusion layer on the anode side. A foamed metal of a nickel-chromium alloy was arranged on the outside of the cathode gas diffusion layer to form an air intake layer. Current collectors provided with channels and provided by plating stainless steel with gold were arranged on the cathode and anode, and the laminates were sandwiched from both sides with stainless steel end plates and fixed with tightening members.

The assembled fuel cells were placed in an environment test machine and evaluated under environment conditions of 25° C. and 50% RT. Hydrogen was supplied as a fuel to the anode. As for the oxidizing agent, the measurements were performed under a natural intake of air from the air intake layer of the cathode. The evaluation was performed under these conditions by a transition of voltage in the case the current density was increased from 0 A to 10 mA/cm² till the output voltage dropped to 0.05 V.

The voltage values at the maximum current density and the current density of 0.4 mA/cm² of the fuel cell in the examples and comparative examples are shown in Table 1.

TABLE 1

| | Maximum Current | Voltage Value |
|---|---|---|
| | Density (A/cm²) | (V) of 0.4 A/cm² |
| Example 1 | 0.588 | 0.663 |
| Example 2 | 0.580 | 0.649 |
| Example 3 | 0.575 | 0.642 |
| Example 4 | 0.586 | 0.640 |
| Comparative Example 1 | 0.505 | 0.601 |
| Comparative Example 2 | 0.513 | 0.600 |
| Comparative Example 3 | 0.484 | 0.545 |

In the examples of the present invention, measurements could be conducted till the current density became equal to or higher than 0.58 A/cm². This result demonstrates that even when the amount of generated water at a high current density has increased, the generated water could be smoothly discharged, thereby substantially preventing the intake of air from being inhibited by the accumulation of generated water. Because of this result, the fuel cell performance was found to be superior to that in the comparative example in which the fluororesin was used alone, and the comparative example using the fluororesin having no functional groups, in particular in a region with a high current density where the amount of generated water increased.

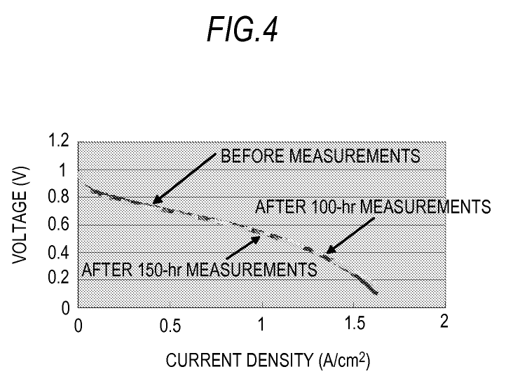

Furthermore, even when the fuel cell including the membrane electrode assembly A that used the catalyst layer in accordance with the present invention generated power continuously for a long time, the deterioration thereof was found to be extremely small. A continuous power generation test was conducted by alternately repeating 10-min power generation cycles at a constant voltage of 7.5 V and 10-min cycles in an OCV state. The transition of voltage when the current density was increased from 0 A to 10 mA/cm² till the output voltage dropped to 0.05 V was measured after testing for 37 h, 100 h, and 150 h. The gas flow rate during these measurements was constant: 2000 ccm of the air at the cathode side and 500 ccm of hydrogen at the anode side. The measurement results are shown in FIG. 4.

FIG. 4 demonstrates that a current-voltage characteristic practically does not change even after 150 h. Therefore, a fuel cell can be provided that demonstrates relatively small deterioration and excellent endurance even when the catalyst layer in accordance with the present invention is installed in the battery cell and it is used for a relatively long time.

Because the catalyst layer of the examples in accordance with aspects of the present invention may improve the discharge of generated water during power generation in the fuel cell and may greatly increase the output, this catalyst layer may be suitable for fuel cells that can produce a high output even in power generation in a fairly high-humidity environment or in power generation at a relatively high current density.

In accordance with the examples illustrating aspects of the present invention, it may be possible to provide a catalyst layer that can improve an output characteristic by inhibiting and even preventing flooding caused by accumulation of generated water during power generation in a solid polymer fuel cell.

Furthermore, the examples according to aspects of the present invention may provide a fuel cell in which the discharge of generated water can be effectively realized and effective power generation can be performed even during relatively long-term power generation, such as when a comparatively large amount of water is generated over a relatively long period, or in a fairly high-humidity environment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-072354, filed Mar. 19, 2008, which is hereby incorporated by reference herein in its entirety.

What is claimed is:

1. A catalyst layer of a solid polymer fuel cell, comprising:
a catalyst structural body;
a membrane present on at least part of a surface of the catalyst structural body and comprising a first water-repellent material having a functional group;
particles comprising a second water-repellent material; and
an electrolyte.

2. The catalyst layer of the solid polymer fuel cell according to claim 1, wherein the functional group is of at least one kind selected from the group consisting of a silane group, a phosphate group, a carboxyl group, and a hydroxyl group.

3. The catalyst layer of the solid polymer fuel cell according to claim 1, wherein both the membrane comprising the first water-repellent material having the functional group and the particles comprising the second water-repellent material comprise a fluororesin.

4. The catalyst layer of the solid polymer fuel cell according to claim 1, wherein a content ratio of the particles comprising the second water-repellent material in the catalyst layer is equal to or higher than 10 mass % and equal to or lower than 60 mass % of the catalyst structural body.

5. The catalyst layer of the solid polymer fuel cell according to claim 1, wherein an average size of the particles comprising the second water-repellent material is equal to or greater than 0.1 μm and equal to or less than 0.5 μm.

6. The catalyst layer of the solid polymer fuel cell according to claim 1, wherein the membrane comprising the first water-repellent material having the functional group is present on at least part of the surface of the catalyst structural body at a ratio of equal to or greater than 1 μg/cm² and equal to or less than 1000 μg/cm².

7. The catalyst layer of the solid polymer fuel cell according to claim 1, wherein the catalyst structural body has a dendritic shape.

8. A membrane electrode assembly comprising the catalyst layer according to claim 1 and a polymer electrolyte membrane.

9. A fuel cell comprising the membrane electrode assembly according to claim 8, a gas diffusion layer, and a current collector.

10. A catalyst layer of a solid polymer fuel cell, comprising:
a catalyst structural body;
a membrane present on at least part of a surface of the catalyst structural body and comprising a first fluororesin having a functional group selected from the group consisting of a silane group, a phosphate group, a carboxyl group, and a hydroxyl group;
particles comprising a second fluororesin; and
an electrolyte.
